(19) United States
(12) Patent Application Publication
(10) Pub. No.: US 2024/0081576 A1
(43) Pub. Date: Mar. 14, 2024

(54) BEVERAGE SYSTEM

(71) Applicant: SOCIETE DES PRODUITS NESTLE S.A., Vevey (CH)

(72) Inventors: AUDREY VIRGINIE MURPHY, Cossonay (CH); NIHAN DOGAN, La-Croix-sur-Lutry (CH); MARILYNE ISABELLE BONIN, Les Grangettes (FR)

(21) Appl. No.: 18/263,181

(22) PCT Filed: Jan. 26, 2022
(86) PCT No.: PCT/EP2022/051697

§ 371 Date: Jul. 27, 2023

(30) Foreign Application Priority Data
Jan. 29, 2021 (EP) 21154182.6

(51) Int. Cl. A47J 31/06; A47J 31/36; A47J 31/40

(52) U.S. Cl. CPC A47J 31/0673; A47J 31/369; A47J 31/407

(57) ABSTRACT

The present invention is directed to a device (19) for adapting different types of ingredient capsules (2A, 2B) in a food or beverage preparation machine (1). Said device (19) is constructed to be removably attached to an existing capsule holder (7) of said machine (1).

### FIELD OF THE INVENTION

The present invention concerns a beverage preparation machine adapted to receive an ingredient package such as a capsule. More precisely, the invention concerns a device to be adapted at the interface between the machine and the ingredient package, for preparing beverages from an existing machine, but with ingredient capsules having new and different structures and functioning principles.

### BACKGROUND OF THE INVENTION

The beverage preparation machine useful in the context of the invention is typically of the type disclosed in Applicant's European Patent EP 2131704 B1. Such a machine comprises a beverage machine casing with functional elements comprising: a fluid source (in the rest of the present patent specification, the fluid will be referred to as water), for instance a water reservoir, a water pump, a water heater, a set of water-conducting pipes. The machine further comprises a brewing chamber for adapting an ingredient container such as a coffee capsule, said chamber being connected fluidly to the rest of the functional elements such that water can be brought into the chamber for mixing with the ingredient contained in the capsule.

The existing machine of interest in the course of the present invention is a multi-recipe beverage preparation system, that involves different types in ingredients and capsules.

The first type of ingredient is coffee, in the roast and ground form, that is extracted within the capsule at a pressure higher than the atmospheric pressure, by passing heated water within the capsule through the mass of coffee at a fluid pressure which is between 6 and 20 bar (relative pressure), preferably between 8 and 15 bar.

The second type of ingredient is made of soluble powders, especially milk-based powders (which can alternatively be tea-based, plant-based, herbal compositions, soups, chocolate-based preparations, etc.). Such soluble ingredients are dissolved by passing through water (preferably heated) within the capsule at a fluid pressure which is close to, or identical to atmospheric pressure (0 to 2 bar).

Due to the difference in nature of the ingredient, and of fluid pressure that is required for preparation of the beverage, the capsules for roast and ground coffee, and for solubles, are structured differently. The general principle remains the same, as described for instance in EP 1 472 156 B1: the capsule comprises a cup defining an ingredient compartment; it is closed at its top by a membrane pierceable by a machine injection plate adapted to inject water under pressure in the capsule; and it comprises a pierceable dispensing wall at its bottom that is opened by opening means when pressure builds-up inside the capsule. However, the bottom opening means are different in their shape, and the pierceable dispensing wall has a different thickness in roast and ground, or soluble types of capsules, such that the pressure that is required for opening the soluble capsules is lower than that required for opening roast and ground coffee capsules.

Further, soluble ingredients, in particular milk-based ingredients are sensitive to bacteria growth, therefore it is essential that products prepared therefrom do not stay in contact with the beverage preparation machine after preparation, and especially if the beverage preparation machine is not used over long periods of time. For this reason, in existing capsules, the bottom of the capsule body preferably extends below the opening means to hold said opening means and in order to collect the beverage to a beverage outlet 25 dispensing the beverage outside of the capsule 1, e.g. into a cup. This bottom portion or dispensing channel of the capsule, that collects and dispenses beverage, prevents product exiting the capsule from contacting the machine surface, which flows directly to the cup.

Yet, this dispensing channel represents a certain amount of capsule material. And this dispensing channel is needless when the capsule comprises roast and ground coffee because the applicant found, that such bacterial growth is extremely reduced, or even inexistent with roast and ground coffee. Further, in a commitment to reduce the amount of packaging used for making capsules, and to choose new packaging materials that are sustainable for the environment, there is a need to improve the structure, shape, size and constitutive material of the capsules as much as can be. The applicant found that capsules for roast and ground can be simplified and re-designed by removing the dispensing channel, as well as the opening means (such as described in EP 1 472 156 B1) that are normally integrated in the capsule; however, by doing this, the main problem that arises is to provide a means that allows the consumer to use functionally both types of capsules (for soluble and for roast and ground), especially the newly modified capsules for coffee, without the necessity to replace the existing machine.

An additional problem was encountered by the applicant when modifying the capsule to achieve an even more sustainable packaging solution, that is: when changing the constitutive material used for manufacturing the capsules, in particular when using compostable or generally biodegradable polymers. More precisely, it was found that using such biodegradable polymers as polylactic acid (PLA), polyhydroxyalcanoates (PHA), polybutylene succinate (PBS), polybutylene succinate adipate (PBSA), or polybutylene adipate terepthalate (PBAT) or similar compostable materials, the environmental footprint is particularly improved which is an excellent outcome that the applicant was looking for, however such materials have a detrimental effect on the mechanical strength of the capsule. The applicant has found that such materials are less rigid than traditional oil-based polymers such as for instance polypropylene. As a result, the capsules made of biodegradable materials deform during preparation of a beverage, and this even more true as water injected therein in hot, and as pressure inside the capsule increases. In usual conditions when the capsule cup is manufactured from polypropylene or similar oil-based material, the seal between the capsule cup and the top membrane through which water is injected, is pinched and held between the upper surface of the capsule holder of the machine and the lower surface of the water injection plate of the machine, as explained in EP 2 131 704 B1. In the case of a capsule made of biodegradable materials such as for instance PHA, the capsule deforms during extraction within the capsule holder, such that the rim upper portion of the capsule cup onto which the upper membrane is sealed, is no longer held properly, which causes delamination between said rim portion and said membrane, which leads to undesirable leakage.

### SUMMARY OF THE INVENTION

In a first aspect, the present invention as claimed in the appended claims solves the above technical problems with a system for preparing food or beverage products, comprising:
a machine that comprises fluid circulation means to circulate a fluid to the capsule, a capsule holder having a housing for holding said capsule, and an injection plate for injecting said fluid into the capsule compartment, said holder and plate being movable relative to one another in order to enclose said capsule when said rim and upper membrane are positioned between said capsule holder and said plate during food or beverage preparation,
a first type of capsule that comprises a capsule body having side walls forming an ingredient compartment, an upper membrane closing the upper part of the body and attached on the upper surface of a rim extending outwardly from the side walls, and a bottom membrane closing the lower part of the body, said bottom membrane being openable by opening means under the effect of the rise in pressure within the capsule compartment,
a second type of capsule comprising a lower rigid wall attached to the side walls such that the bottom membrane is located within the capsule compartment, above the upper surface of said rigid wall, the second type of capsule further comprising a product-dispensing channel connecting the upper and lower sides of said lower rigid wall, and a product-dispensing conduit extending downwardly from said product dispensing channel, the upper surface of said lower rigid wall comprising opening means adapted to open said bottom membrane, and
a device for adapting the first and second types of capsule in the capsule holder of the food or beverage preparation machine, wherein said device comprises:
   a device plate with attachment means to the capsule holder,
   opening means located at the upper surface of said device plate, said opening means protruding upwardly from the upper surface plane of said device plate, said opening means being adapted to open the bottom membrane of the first type of capsule in order to allow a first type of food or beverage product to be dispensed, and
   a central through-hole extending through the whole thickness of said plate, for receiving the product-dispensing conduit of said second type of capsule.

This system enables the production of capsules with a reduced quantity of material since the first type of capsule (that usually comprises roast and ground coffee) is deprived of opening means and the body of this capsule is deprived of bottom portion or dispensing channel, for collecting and dispensing beverage.

Preferably, the opening means are formed of at least one piercing element adapted to pierce through the bottom membrane of the first type of capsule. And more preferably, the bottom membrane is a thin film adapted to be pierced through its thickness. Also advantageously, said piercing element is a pyramid-shaped protrusion.

In one embodiment of the invention, the attachment means of the device plate to the capsule holder are means allowing a non-permanent and reversible attachment. In the simplest manner, attachment means can be corresponding shapes between the lower surface of the device plate and the bottom of the internal surface of the capsule holder.

Accordingly, the device for adapting the first and second types of capsule in the capsule holder can be removed for cleaning and then positioned again in the capsule holder.

In another preferred embodiment of the invention, the central through-hole of the device is surrounded, at the upper surface of the device plate, by a circular wall protruding upwardly from said upper surface, at a height which is at least equal, or superior, to the height of the opening means.

The device plate according to the invention advantageously comprises a peripheral plate rim extending horizontally and outwardly from said plate, said plate rim having a thickness comprised between 0.3 mm and 3 mm, preferably between 0.4 mm and 1.0 mm.

In an alternative embodiment of the invention, the device according to the invention further comprises pillars extending upwardly from the peripheral edge of the device plate, said pillars joining at their upper tips, an annular ring having a flat or O-ring cross section (preferably, the annular ring is flat). Thanks to this annular ring, the leaking rate was reduced from up to 100% to 0-2% depending on the machine type, which can be explained by the fact that said ring increases the thickness of the capsule rim that is pinched between the injection plate and the capsule holder when the machine is functionally closed. Such an increased thickness therefore also increases the closing force applied by the injection plate and capsule holder, which prevents delamination of the upper membrane of the capsule from the capsule rim. The annular ring preferably has a thickness comprised between 0.1 mm and 2 mm, preferably between 0.5 mm and 1.0 mm.

In addition, attaching the adapting device to these pillars prevents the user from throwing away this adapting device with a used capsule when the user throws the capsule away in a bin. The pillars makes the adapting device more noticeable.

Advantageously, the device plate comprises a plurality of through-holes extending between its upper and lower sides, and located between the piercing element(s), said holes having a diameter comprised between 0.1 and 1 mm, preferably about 0.4 mm.

The dispensing conduit of the second type of capsules preferably has an external diameter comprised between 2 mm and 8 mm, preferably between 4 mm and 5 mm. The bigger the central conduit, the thicker the supporting walls needs to be for the membrane.

In one possible embodiment of the invention, the central through hole of the device plate comprises a valve (a plastic insert with slits), adapted to open when the product-dispensing conduit of a second type of capsule is inserted within said central through hole, and to reclose leak-tightly when no conduit is present.

Preferably, at least the capsule bodies of the capsules are made of compostable or biodegradable polymers and are preferably made of polylactic acid (PLA), polyhydroxyalcanoates (PHA), polybutylene succinate (PBS), polybutylene succinate adipate (PBSA), or polybutylene adipate terepthalate (PBAT) and mixtures thereof.

In one second aspect, there is provided a device for use in the system such as described above, wherein said device comprises:
a device plate with attachment means to the capsule holder,
opening means located at the upper surface of said device plate, said opening means protruding upwardly from the upper surface plane of said device plate, said opening means being adapted to open the bottom membrane of the first type of capsule in order to allow a first type of food or beverage product to be dispensed, and
   wherein the central through-hole of said device plate is surrounded, at the upper surface of the device plate, by a circular wall protruding upwardly from said upper surface, at a height which is at least equal, or superior, to the height of the opening means.

Preferably this device plate comprises a peripheral plate rim extending horizontally and outwardly from said plate, said plate rim having a thickness comprised between 0.3 mm and 3 mm, preferably between 0.4 mm and 1.0 mm.

In one embodiment, the adapting device further comprises at least three pillars extending upwardly from the peripheral edge of the device plate, said pillars joining at their upper tips an annular ring.

In a third aspect, there is provided a kit for use with a machine, said machine comprising fluid circulation means to circulate a fluid to a capsule of a first or second type, a capsule holder having a housing for holding said capsule, and an injection plate for injecting said fluid into the capsule compartment, said holder and plate being movable relative to one another in order to enclose said capsule, said kit comprising:
an adapting device such as described above, and
several capsules of the first type and/or several capsules of the second type.

By several, it is meant at least 2. The number of capsules associated to one single adapting device can depend on the mechanical strength of this adapting device or can take into account the necessity to change the adapting device further to its increased dirtiness due to the deposits of beverage residues.

For example, the kit can comprise one opening device for 12 capsules.

The kit can comprise the first type of capsules only or the second type of capsules only or a mix of both types of capsules.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a partial cut perspective view of a beverage preparation machine into which the invention is to be used;

FIG. 2 is a perspective view of a capsule holder (loaded with a capsule) and water injection unit in open position, of a beverage machine illustrated in FIG. 1;

FIG. 3 is a lateral view of a capsule holder inserted in the water injection unit, in open position, similar to FIG. 2;

FIG. 4 is a lateral view of a capsule holder inserted in the water injection unit, in closed position, similar to FIG. 3;

FIG. 5 is a perspective view of an ingredient capsule having a delaminated upper membrane;

FIG. 6 is a sectional cross view of a first type of capsule;

FIG. 7 is a sectional cross view of a second type of capsule;

FIG. 8 is a perspective top view of a first embodiment of a device according to the invention;

FIG. 9 is a perspective cut view of a first embodiment of a device similar to that of FIG. 8;

FIG. 10 is a lateral cut view of a device shown in FIGS. 8 and 9, that is functionally assembled to a first type of capsule, and inserted into the brewing chamber of a beverage preparation machine;

FIG. 11 is a lateral cut view of a device shown in FIGS. 8 and 9, that is functionally assembled to a second type of capsule, and inserted into the brewing chamber of a beverage preparation machine;

FIG. 12 is a perspective top view of a second embodiment of a device according to the invention;

FIG. 13 is a perspective cut view of a second embodiment of a device similar to that of FIG. 12;

FIG. 14 is a lateral cut view of a device shown in FIGS. 12 and 13, that is functionally assembled to a first type of capsule, and inserted into the brewing chamber of a beverage preparation machine;

FIG. 15 is a lateral cut view of a device shown in FIGS. 12 and 13, that is functionally assembled to a second type of capsule, and inserted into the brewing chamber of a beverage preparation machine;

FIG. 16 is a perspective top view of a third embodiment of a device according to the invention;

FIG. 17 is a perspective cut view of a third embodiment of a device similar to that of FIG. 16;

FIG. 18 is a lateral cut view of a device shown in FIGS. 16 and 17, that is functionally assembled to a first type of capsule, and inserted into the brewing chamber of a beverage preparation machine;

FIG. 19 is a lateral cut view of a device shown in FIGS. 16 and 17, that is functionally assembled to a second type of capsule, and inserted into the brewing chamber of a beverage preparation machine.

### DETAILED DESCRIPTION OF EXEMPLARY EMBODIMENTS

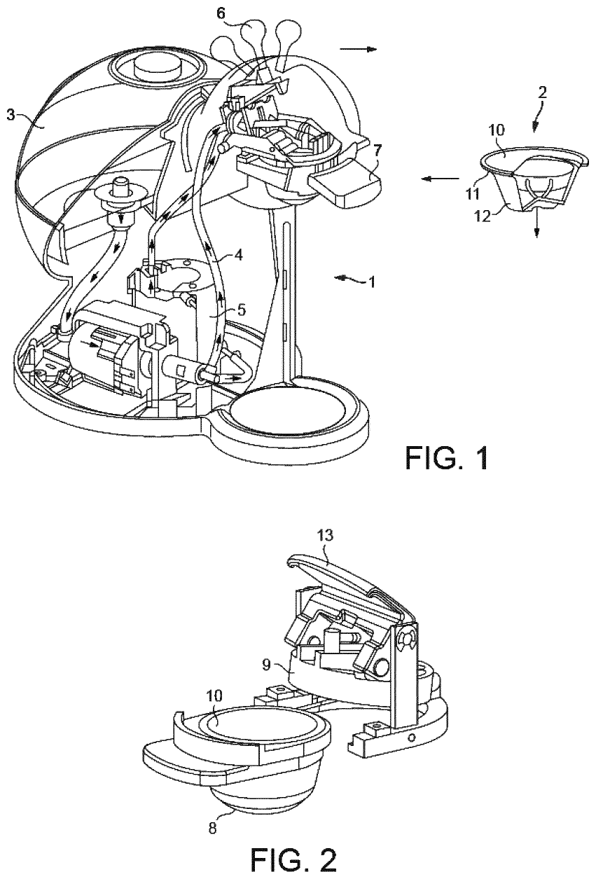

FIG. 1 illustrates a food or beverage preparation machine 1 for use with a closed ingredient capsule 2. The machine 1 comprises fluid circulation means to circulate a fluid (in the rest of the present description it is water) to the capsule 2, for mixing said fluid with ingredient for forming a food or beverage (in the rest of this description, it is considered that the machine is for preparing a beverage such as coffee, tea, soups, nutritional compositions and the like). The fluid circulation means comprise a water tank 3, a set of pipes 4, a water heater 5, and a fluid circulation actuator 6.

The machine of FIG. 1 further comprises a capsule holder 7 having a housing 8 for holding said capsule 2. It further comprises an injection plate 9 for injecting said fluid into the capsule compartment through an upper membrane 10 of the capsule 2. The upper membrane 10 of the capsule 2 is attached to the upper surface of a capsule rim 11 that extends outwardly from the top of capsule side walls 12.

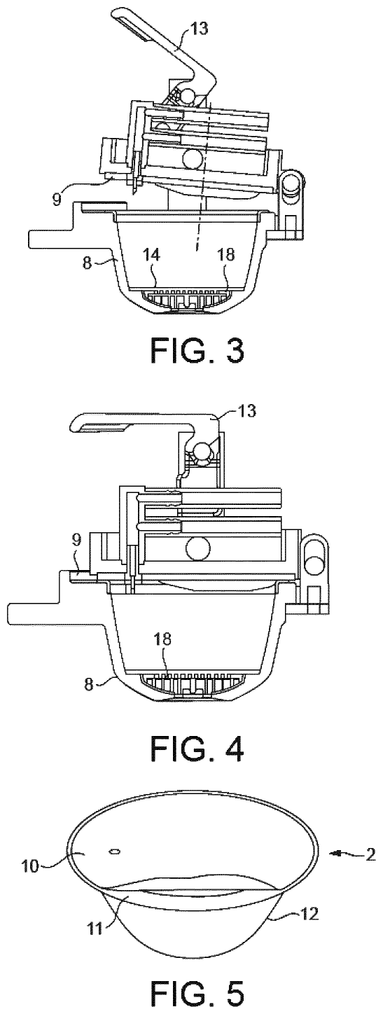

In the embodiments of a beverage preparation machine described in the present application, the term “brewing chamber” generally refers to the assembly of a capsule holder 7 with the water injection plate 9. As illustrated in FIGS. 2 to 4, the capsule holder 7 and injection plate 9 are movable relative to one another in order to enclose said capsule 2, when the capsule rim 11 and the upper membrane 10 of the capsule 2 are positioned between said capsule holder 7 and said water injection plate 9 during food or beverage preparation. In FIG. 2 is shown a capsule 2 in position within the housing 8 of the capsule holder 7, and the water injection plate 9 within the machine, which is lifted in an upward position to allow insertion of the capsule holder within said machine 1. In FIG. 3, the capsule holder 7 is inserted within the machine 1 and the water injection plate 9 is still lifted. In FIG. 4, the water injection plate 9 is moved towards the capsule holder in a functional position of the machine 1, ready for beverage preparation. Moving the water injection plate 9 between its positions described before, can be done automatically by pressing a command on a machine control panel, or alternatively it can be done manually by the user by pivoting an actuation lever 13 shown as an example in FIGS. 3 and 4.

In the functional position of the brewing unit, when the water injection plate is moved towards the capsule holder (FIG. 4), the capsule rim 11 and the upper membrane 10 of the capsule 2 are positioned between said capsule holder 7 and said water injection plate 9 and held therein.

Generally, the principle of opening of the capsules is that when water is injected within the capsule, water pressure increases inside the capsule, until pressure is sufficient to rupture a wall at the dispensing side of said capsule, in order to allow product to flow out towards the used cup. Rupture of the capsule dispensing wall is achieved by interaction of said dispensing wall with opening means integrated in the capsule construction, under the effect of pressure rise inside the capsule.

In order to provide more environmentally friendly capsules, the applicant has developed capsules constructed from less material, and in particular some capsules that do not comprise their own integrated opening means. However, there is still a necessity that the beverage machine can adapt another type of capsules that still comprise their own opening means.

The beverage machine described above therefore needs to adapt different types of capsules, one of which is deprived of its own opening means.

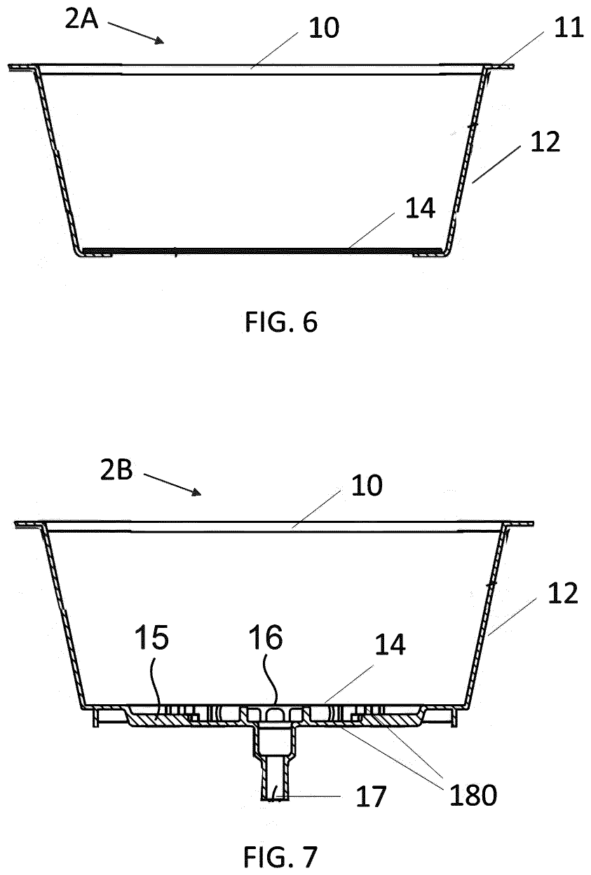

More precisely, FIG. 6 describes a first type of capsule 2A that comprises a capsule body having side walls 12 forming an ingredient compartment, an upper membrane 10 closing the upper part of the body and attached on the upper surface of a rim 11 extending outwardly from the side walls 10, and a bottom membrane 14 closing the lower part of the body, said bottom membrane 14 being openable by opening means under the effect of the rise in pressure within the capsule compartment.

FIG. 7 describes a second type of capsule 2B that comprises, in addition to the features of the first type of capsules described above, a lower rigid wall 15 attached to the bottom edge of the side walls 12 such that the bottom membrane 14 is located inside the capsule compartment, above the upper surface of said rigid wall. Said second type of capsule 2B further comprises a product-dispensing channel 16 connecting the upper and lower sides of said lower rigid wall 15, and a product-dispensing conduit 17 extending downwardly from said product dispensing channel 16. The upper surface of said lower rigid wall 15 comprises integrated opening means 180 adapted to open said bottom membrane.

In the first type of capsule 2A, the opening means for opening the bottom membrane are not integrated in the capsule, whereas said opening means are integrated in the second type of capsules 2B. In the latter, the opening means are present at the upper surface of the lower rigid wall 15.

In both cases, the opening means—whether or not they are integrated in the capsule—are formed of at least one, but preferably (as illustrated), a plurality of piercing elements 18, 180 adapted to pierce through the bottom membrane 14 of the capsule. Said bottom membrane 14 is preferably a thin film adapted to be pierced through its thickness. Advantageously, this piercing element is a pyramid-shaped protrusion.

According to the present invention is provided a device 19 for adapting at least two types of ingredient capsules in the same beverage preparation machine 1, namely the first and second types of capsules 2A, 2B described above.

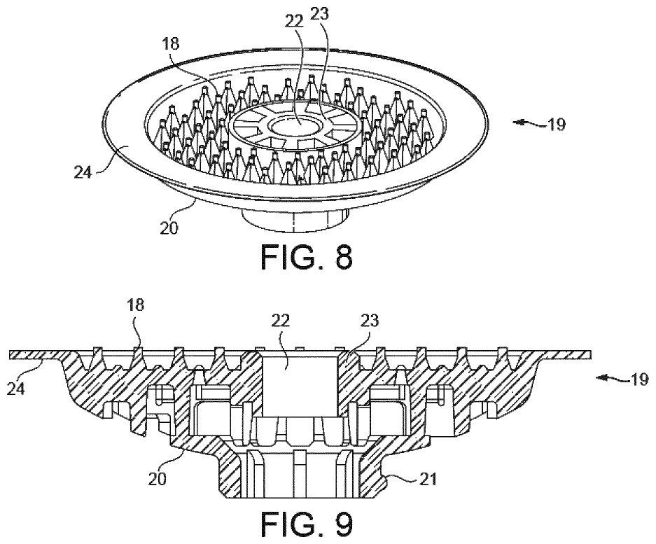

As illustrated in FIGS. 8 and 9, this device 19 comprises:
a device plate 20 with attachment means 21 to the capsule holder 7,
opening means 18 located at the upper surface of said device plate 20, said opening means 18 protruding upwardly from the upper surface plane of said device plate, said opening means being adapted to open the bottom membrane of the first type of capsule 2A in order to allow a first type of food or beverage product (preferably coffee) to be dispensed, and
a central through-hole 22 extending through the whole thickness of said plate 20, for receiving the product-dispensing conduit 17 of the second type of capsule 2B.

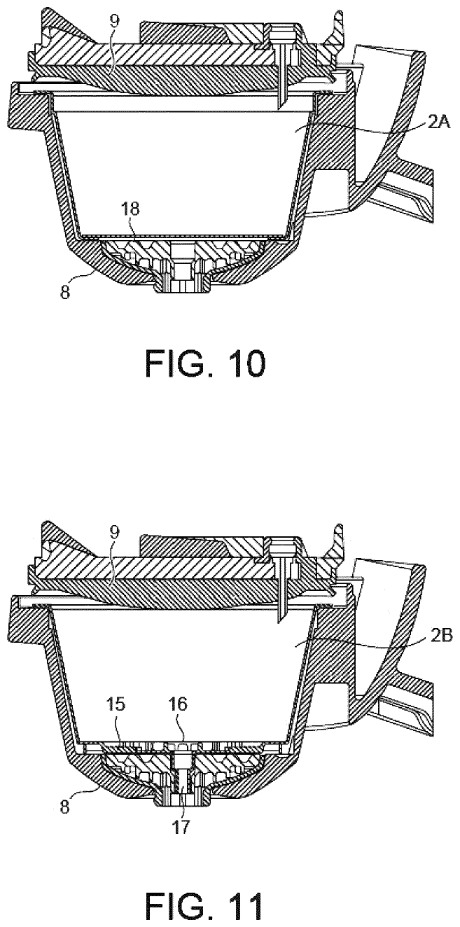

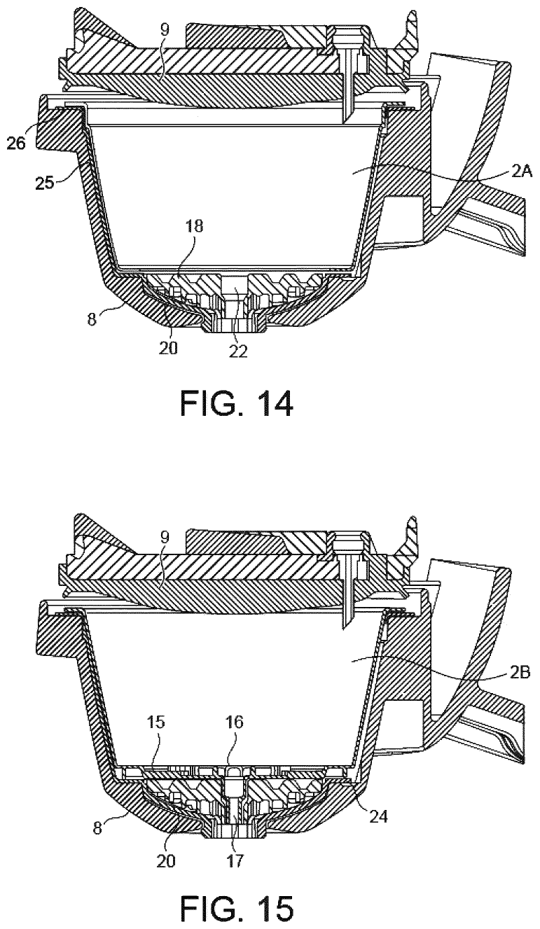

The device plate 20 comprises a plurality of through-holes (not illustrated) extending between its upper and lower sides, and located between the piercing element 18, said holes having a diameter comprised between 0.1 and 1 mm. Such holes serve to guide the flow of beverage dispensed from the first type of capsules towards the cup. In this configuration, as shown in FIGS. 10, 14 and 18, the beverage is dispensed across the entire lower surface of the capsule, and requires guiding and dispensing through the device plate, thanks to said plurality of through-holes. In the case of the second type of capsules, the beverage is dispensed through the product dispensing conduit 17, such that the through-holes of the plate do not play any role for the beverage dispensing.

The cooperation of this first type of capsule 2A with the capsule holder 8 and the adapting device 19 is illustrated in FIGS. 10, 14, 18.

The cooperation of this first type of capsule 2A with the capsule holder 8 and the adapting device 19 is illustrated in FIGS. 11, 15, 19.

In the embodiment of the invention illustrated in FIGS. 8 and 9, the attachment means of the device plate 20 to the capsule holder 7 are means allowing a non-permanent and reversible attachment, in particular a set of protrusions 21 extending laterally from the lower portion of the plate 7 and having a dimension such that the plate can be inserted into the housing 8 of the capsule holder 7, and such dimension that allows a mechanical reversible retention effect.

In another preferred embodiment of the invention illustrated also in FIGS. 8 and 9, the central through-hole 22 of the device plate 20, is surrounded at the upper surface of the device plate, by a circular wall 23 protruding upwardly from said upper surface, at a height which is at least equal, or superior, to the height of the piercing elements 18. This circular wall 23 provides a support for the centre of the bottom membrane 14 of the first type of capsule 2A and avoids that said membrane is pierced by the piercing elements 18 when the capsule is simply positioned inside the capsule holder before any water is introduced inside the capsule and beverage is prepared.

As illustrated in FIG. 5, it was found also that in certain circumstances, and in particular when the material upper membrane 10 is changed from a traditional polymer such as polypropylene (PP) or polyethylene (PE) for instance, towards a compostable, environmentally-friendly material, problems of delamination of the upper membrane 10 can occur. Such delamination effect leads to undesired opening—even partial—or generally lifting of the upper membrane from the rest of the capsule side walls 12 and capsule rim 11, as illustrated in FIG. 5. The process of delamination is leads eventually to weakening and undue piercing through the membrane 10, which leads to leakage. Compostable material do not reach same material properties than traditional polymer especially under hot water condition. Most of the compostable material have approximately 10 time less seal strength (expressed in N/mm) than polypropylene (PP) and lead to delamination of the upper membrane 10 as illustrated in the FIG. 5.

To solve the delamination issue, it was found surprisingly that by lifting the capsule within the capsule holder, when said capsule is in place within said holder, the capsule rim 11 and the upper membrane 10 are better held in place between the water injection plate and capsule holder, when the brewing unit is in its closed configuration, ready for beverage preparation, and any potential deformation of the capsule rim 11 within the brewing unit—which was found to also enhance delamination issues—is limited. It was shown that brewing unit deforms under pressure during beverage preparation process and this impact on the capsule body and its resulting on delamination of top layers was compensated by the elevated capsule.

To obtain this lifting effect of the capsule, the device plate 20 according to the invention advantageously comprises a peripheral plate rim 24 illustrated in FIGS. 8 and 9, that extends horizontally and outwardly from said plate. The plate rim 24 has a thickness comprised between 0.3 mm and 3 mm, preferably between 0.4 mm and 1 mm.

When the capsule and capsule holder are inserted within the brewing unit of the machine, the plate rim 24 is placed between the lower part of the capsule holder and the bottom of the capsule, and the thickness of said rim 24 is sufficient to obtain the above mentioned lifting effect.

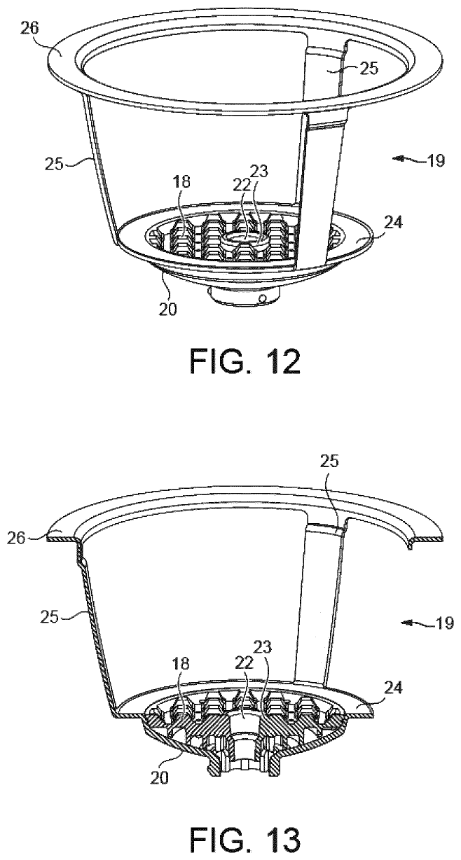

In an alternative or combined embodiment of the invention illustrated in FIGS. 12 to 15, the device according to the invention further comprises at least three pillars 25 extending upwardly from the peripheral edge of the device plate 20. Said pillars 25 join at their upper tips, to an annular flat ring 26. With the cage, thanks to the support at the top plus elevated capsule body, the delamination of top membrane can be minimized. The annular flat ring preferably has a thickness comprised between 0.1 mm and 2 mm, preferably between 0.4 mm and 1 mm.

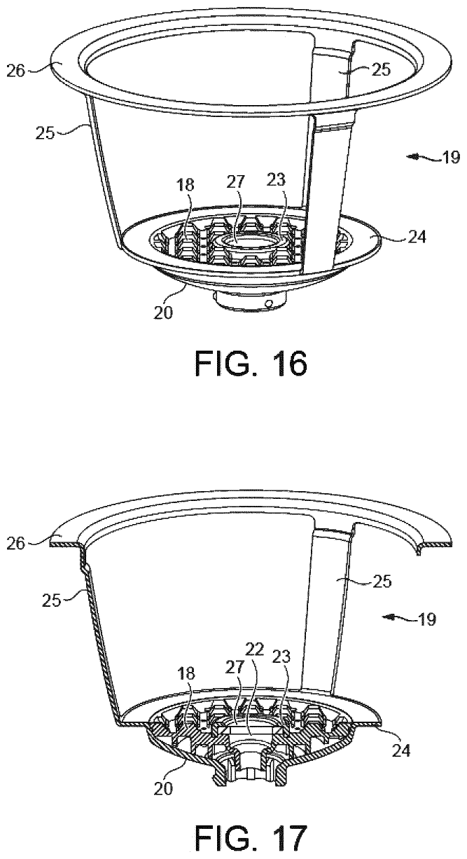

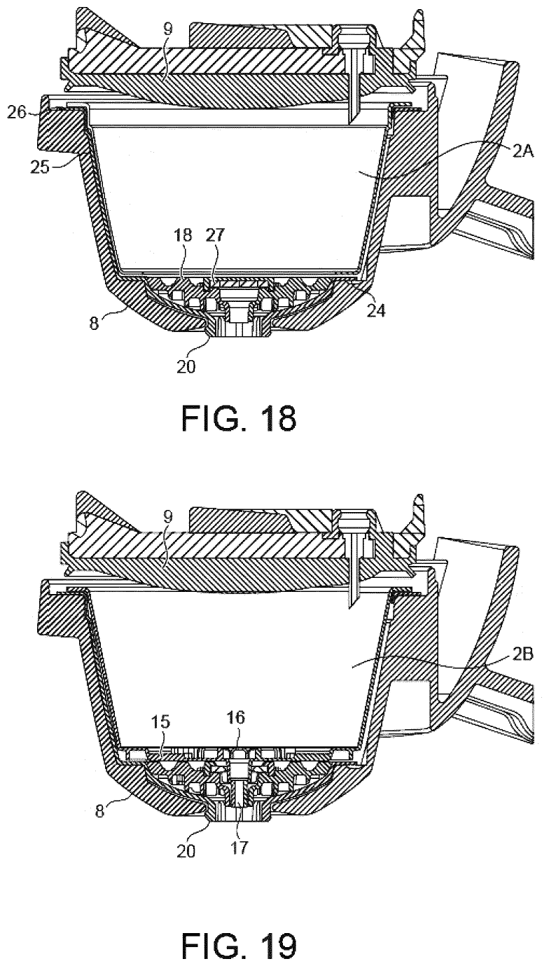

In another embodiment of the invention illustrated in FIGS. 16 to 19, the central through hole 22 of the device plate 20 can comprise a valve 27 adapted to open when the product-dispensing conduit 17 of the second type of capsule is inserted within said central through hole (as shown in FIG. 19), and to reclose leak-tightly when no conduit is present, for example when a capsule of the first type 2A is inserted in the capsule holder 7 and device 19 (as shown in FIG. 18). Such a valve 27 closes the central through-hole when a capsule of the first type 2A is inserted in the brewing unit, to ensure that the beverage that is dispensed flows through the plurality of dispensing through-holes of the plate 20, as described above.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A system for preparing food or beverage products, comprising:
a machine comprising:
fluid circulation member to circulate a fluid to a capsule,
a capsule holder having a housing for holding said capsule, and
an injection plate for injecting said fluid into the capsule compartment,
said holder and plate being movable relative to one another in order to enclose said capsule,
a first type of capsule, said capsule comprising a capsule body having side walls forming an ingredient compartment, an upper membrane closing the upper part of the body and attached on the upper surface of a rim extending outwardly from the side walls, and a bottom membrane closing the lower part of the capsule body, said bottom membrane being openable by an opener under the effect of the rise in pressure within the capsule compartment, and
a second type of capsule comprises said capsule comprising a capsule body having side walls forming an ingredient compartment and a lower rigid wall attached to the side walls such that the bottom membrane of said second type of capsule is located within the capsule compartment, above the upper surface of said rigid wall, the second type of capsule further comprising a product-dispensing channel connecting the upper and lower sides of said lower rigid wall, and a product-dispensing conduit extending downwardly from said product dispensing channel, the upper surface of said lower rigid wall comprising an opener adapted to open said bottom membrane, and
a device for adapting the first and second types of capsule in the capsule holder of the food or beverage preparation machine, wherein said device comprises:
a device plate with an attachment member to the capsule holder,
the opener located at the upper surface of said device plate and protruding upwardly from the upper surface plane of said device plate, said opener being adapted to open the bottom membrane of the first type of capsule in order to allow a first type of food or beverage product to be dispensed, and
a central through-hole extending through the whole thickness of said plate, for receiving the product-dispensing conduit of said second type of capsule.

2. A system according to claim 1, wherein the opener of the adapting device is formed of at least one piercing element adapted to pierce through the bottom membrane of the first type of capsule.

3. A system according to claim 2, wherein said bottom membrane of the first type of capsule is a thin film adapted to be pierced through its thickness.

4. A system according to claim 2, wherein said piercing element the opening means of the adapting device is a pyramid-shaped protrusion.

5. A system according to claim 1, wherein the attachment means member of the device plate to the capsule holder allows a non-permanent and reversible attachment.

6. A system according to claim 1, wherein the central through-hole of said device plate is surrounded, at the upper surface of the device plate, by a circular wall protruding upwardly from said upper surface, at a height which is at least equal, or superior, to the height of the opening means.

7. A system according to claim 1, wherein said device plate comprises a peripheral plate rim extending horizontally and outwardly from said plate, said plate rim having a thickness of between 0.3 mm and 3 mm.

8. A system according to claim 1, wherein the adapting device further comprises pillars extending upwardly from the peripheral edge of the device plate, said pillars joining at their upper tips an annular ring.

9. A system according to claim 8, wherein said annular ring is flat and has a thickness comprised of between 0.3 mm and 3 mm.

10. A system according to claim 1, wherein the device plate comprises a plurality of through-holes extending between its upper and lower sides, and located between the piercing element(s), said holes having a diameter of between 0.1 and 1 mm.

11. A system according to claim 1, wherein the dispensing conduit of the second type of capsules has an external diameter comprised of 2 mm and 7 mm.

12. A system according to claim 1, wherein the central through hole of the device plate comprises a valve, adapted to open when the product-dispensing conduit of a second type of capsule is inserted within said central through hole, and to reclose leak-tightly when no conduit is present.

13. A system according to claim 1, wherein at least the capsule bodies of the capsules are made of compostable or biodegradable polymers.

14. An adapting device for use in the system for preparing food or beverage products, comprising:
a machine comprising:
fluid circulation member to circulate a fluid to a capsule,
a capsule holder having a housing for holding said capsule, and
an injection plate for injecting said fluid into the capsule compartment,
said holder and plate being movable relative to one another in order to enclose said capsule,
a first type of capsule, said capsule comprising a capsule body having side walls forming an ingredient compartment, an upper membrane closing the upper part of the body and attached on the upper surface of a rim extending outwardly from the side walls, and a bottom membrane closing the lower part of the capsule body, said bottom membrane being openable by an opener under the effect of the rise in pressure within the capsule compartment, and
a second type of capsule comprises said capsule comprising a capsule body having side walls forming an ingredient compartment and a lower rigid wall attached to the side walls such that the bottom membrane of said second type of capsule is located within the capsule compartment, above the upper surface of said rigid wall, the second type of capsule further comprising a product-dispensing channel connecting the upper and lower sides of said lower rigid wall, and a product-dispensing conduit extending downwardly from said product dispensing channel, the upper surface of said lower rigid wall comprising an opener adapted to open said bottom membrane, and
a device for adapting the first and second types of capsule in the capsule holder of the food or beverage preparation machine, wherein said device comprises:
a device plate with an attachment member to the capsule holder,
the opener located at the upper surface of said device plate and protruding upwardly from the upper surface plane of said device plate, said opener being adapted to open the bottom membrane of the first type of capsule in order to allow a first type of food or beverage product to be dispensed, and
a central through-hole extending through the whole thickness of said plate, for receiving the product-dispensing conduit of said second type of capsule wherein said device comprises:
a device plate with attachment means to the capsule holder,
the opener located at the upper surface of said device plate, and protruding upwardly from the upper surface plane of said device plate, said opening means being adapted to open the bottom membrane of the first type of capsule in order to allow a first type of food or beverage product to be dispensed, and
wherein the central through-hole of said device plate is surrounded, at the upper surface of the device plate, by a circular wall protruding upwardly from said upper surface, at a height which is at least equal, or superior, to the height of opener.

15. A device according to claim 1, wherein said device plate comprises a peripheral plate rim extending horizontally and outwardly from said plate, said plate rim having a thickness of between 0.3 mm and 3 mm.

16. A device according to claim 14, wherein the adapting device further comprises at least three pillars extending upwardly from the peripheral edge of the device plate, said pillars joining at their upper tips an annular ring.

17. A device according to claim 16, wherein said annular ring (26) is flat and has a thickness comprised of between 0.3 mm and 3 mm.

18. (canceled)
